(19) United States
(12) Patent Application Publication
(10) Pub. No.: US 2016/0313187 A1
(43) Pub. Date: Oct. 27, 2016

(54) ESTIMATION DEVICE THAT ESTIMATES SURROUNDING ENVIRONMENT AND ESTIMATION SYSTEM

(71) Applicant: JVC KENWOOD Corporation, Yokohama-shi (JP)

(72) Inventor: Keita HAYASHI, Yokohama-shi (JP)

(73) Assignee: JVC KENWOOD Corporation

(21) Appl. No.: 15/136,069

(22) Filed: Apr. 22, 2016

(30) Foreign Application Priority Data
Apr. 24, 2015 (JP) 2015-089356

(51) Int. Cl. G01J 5/02; G01J 5/00; G01J 5/04

(52) U.S. Cl. CPC G01J 5/025; G01J 5/041; G01J 5/0018

(57) ABSTRACT

A first-temperature calculation unit calculates, as a first temperature, a maximum temperature within an image region captured by a far-infrared camera. A second-temperature acquisition unit acquires, as a second temperature, a surrounding temperature measured by a temperature sensor. An estimation unit estimates a surrounding environment on the basis of information on the second temperature acquired by the second-temperature acquisition unit and information on the first temperature calculated by the first-temperature calculation unit. A transmission unit transmits information on the surrounding environment estimated by the estimation unit.

### CROSS-REFERENCE TO RELATED APPLICATION

This application is based upon and claims the benefit of priority from the prior Japanese Patent Application No. 2015-089356, filed on Apr. 24, 2015, the entire contents of which are incorporated herein by reference.

### BACKGROUND

1. Field

The present invention relates to estimation techniques, and in particular relates to an estimation device that estimates a surrounding environment and to an estimation system.

2. Description of the Related Art

Firefighters engaging in firefighting operations operate in locations where they can be exposed to high temperatures of several hundred degrees and fight fires in environments where they are at risk of being burned. In such an environment, firefighters use transceivers to report on the situations and so forth on the site to a commander as appropriate. Thus, the firefighters engage in firefighting operations in an extreme environment while communicating with the commander (see, for example, patent document 1).

[Patent Document 1] Japanese Patent Application Laid-open No. 2000-112558

Meanwhile, the environment changes by the moment in the scene of a fire. The firefighters need to report on such changes in the environment accurately to the commander, but it is difficult to report, using transceivers, to the commander every moment on the environment where the firefighting operation is taking place.

### SUMMARY

To address the aforementioned issue, an estimation device according to an aspect of an embodiment includes a first-temperature calculation unit that calculates, as a first temperature, a maximum temperature within an image region captured by a far-infrared camera; a second-temperature acquisition unit that acquires, as a second temperature, a surrounding temperature measured by a temperature sensor; an estimation unit that estimates a surrounding environment measured by the temperature sensor on the basis of information on the second temperature acquired by the second-temperature acquisition unit and information on the first temperature calculated by the first-temperature calculation unit; and a transmission unit that transmits information on the surrounding environment estimated by the estimation unit.

Another aspect of an embodiment provides an estimation system. The estimation system includes an estimation device that estimates a surrounding environment, and a reception device that receives information on the surrounding environment estimated by the estimation device. The estimation device includes a first-temperature calculation unit that calculates, as a first temperature, a maximum temperature within an image region captured by a far-infrared camera; a second-temperature acquisition unit that acquires, as a second temperature, a surrounding temperature measured by a temperature sensor; and an estimation unit that estimates a surrounding environment measured by the temperature sensor on the basis of information on the second temperature acquired by the second-temperature acquisition unit and information on the first temperature calculated by the first-temperature calculation unit.

It is to be noted that any optional combination of the above-described constituent elements and any embodiment obtained by transforming what is expressed by the present embodiments into a method, an apparatus, a system, a recording medium, a computer program, and so on are also effective as other aspects of the present embodiments.

### BRIEF DESCRIPTION OF THE DRAWINGS

FIG. 1 illustrates a configuration of an estimation system according to Example 1;

FIG. 2 illustrates blocks into which an image is divided by a first-temperature calculation unit illustrated in FIG. 1;

FIG. 3 illustrates a data structure of a table stored in an estimation unit illustrated in FIG. 1;

FIG. 4 is a flowchart illustrating an estimation procedure of an estimation device illustrated in FIG. 1;

FIG. 5 illustrates a configuration of an estimation system according to Example 2;

FIG. 6 illustrates a data structure of a table stored in an adjustment unit illustrated in FIG. 5;

FIG. 7 illustrates a data structure of a table stored in an estimation unit illustrated in FIG. 5;

FIG. 8 is a flowchart illustrating an estimation procedure of an estimation device illustrated in FIG. 5;

FIG. 9 illustrates a configuration of an estimation system according to Example 3;

FIG. 10 illustrates a data structure of a table stored in an estimation unit illustrated in FIG. 9; and

FIG. 11 is a flowchart illustrating an estimation procedure of an estimation device illustrated in FIG. 9.

### DETAILED DESCRIPTION

The invention will now be described by reference to the preferred embodiments. This does not intend to limit the scope of the present invention, but to exemplify the invention.

### EXAMPLE 1

Prior to describing the present invention in concrete terms, an overview will be given first. Example 1 relates to an estimation system constituted by an estimation device and a reception device. The estimation device is to be carried by a firefighter or the like who engages in a rescue operation or a firefighting operation in a high-temperature environment, and the reception device is connected to the estimation device via a cable or wirelessly through a network. The estimation device estimates a surrounding environment and transmits information on the environment via a cable or wirelessly. The reception device receives information from the estimation device and displays the information on the environment where each firefighter operates. Thus, a commander can grasp the environment where the firefighters operate. To implement the above, an operation environment estimation system according to the present example executes the following process.

The estimation device estimates the surrounding environment where the firefighters operate on the basis of information on a maximum temperature within an image region captured by a far-infrared camera (hereinafter, referred to as a first temperature) and information on a surrounding temperature that can be acquired from a temperature sensor (hereinafter, referred to as a second temperature). A plurality of conditions are defined in advance to define the surrounding environment. The estimation device selects one of the conditions to which the surrounding environment corresponds on the basis of the first temperature and the second temperature, and transmits information on the selected condition on via a cable or wirelessly. The reception device receives the information from the estimation device and displays the environment where the firefighters operate. Thus, the commander can recognize a firefighter engaging in a firefighting operation in a dangerous environment. Accordingly, the commander can provide more appropriate instruction to each firefighter, which leads to an improvement in the efficiency of the firefighting operation and to risk prevention.

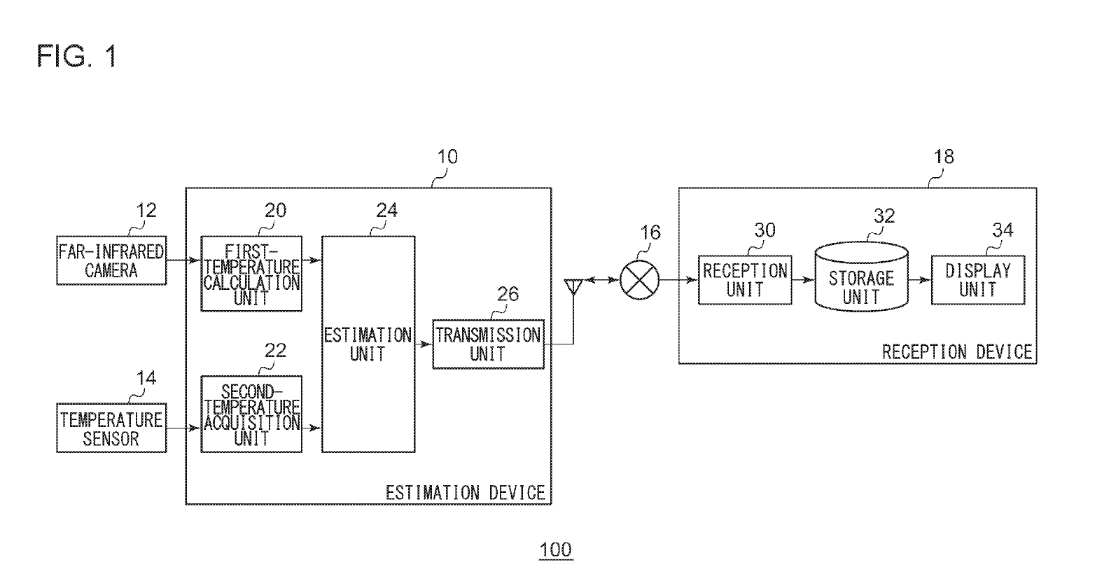

FIG. 1 illustrates a configuration of an estimation system 100 according to Example 1. The estimation system 100 includes an estimation device 10, a far-infrared camera 12, temperature sensor 14, a network 16, and a reception device 18. The estimation device 10 includes a first-temperature calculation unit 20, a second-temperature acquisition unit 22, an estimation unit 24, and a transmission unit 26. The reception device 18 includes a reception unit 30, a storage unit 32, and a display unit 34.

The estimation device 10, the far-infrared camera 12, and the temperature sensor 14 are carried by a firefighter. For example, the far-infrared camera 12 is mounted on a helmet worn by a firefighter, and the estimation device 10 and the temperature sensor 14 are mounted on work wear worn by the firefighter. The far-infrared camera 12 and the temperature sensor 14 are connected to the estimation device 10 via a cable or wirelessly. The estimation device 10 estimates a surrounding environment. An estimation process will be described later.

The reception device 18 is installed at a fire station or in a commander vehicle and is operated by a commander. The reception device 18 receives information on the environment estimated by the estimation device 10. Thus, the commander grasps the environment surrounding the firefighter engaging in the firefighting operation. The estimation device 10 and the reception device 18 are interconnected through the network 16. The network 16 may use a public communication circuit or a dedicated communication circuit. The estimation device 10 and the network 16 are interconnected through a wired circuit or a wireless circuit.

The far-infrared camera 12 converts infrared radiation from an object into a video signal. The far-infrared camera 12 may be implemented by a publicly known technique, and thus description thereof will be omitted herein. The far-infrared camera 12 outputs a captured video signal to the first-temperature calculation unit 20. The first-temperature calculation unit 20 identifies a maximum temperature (as mentioned above, referred to as the first temperature) within the image region captured by the far-infrared camera 12, on the basis of the received video signal.

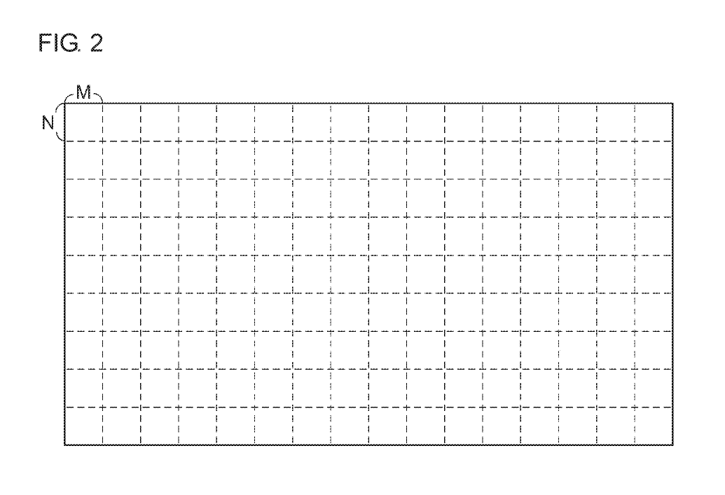

This will be described in concrete terms. The first-temperature calculation unit 20 divides a video signal captured by the far-infrared camera 12 into blocks of M pixels (M>1) horizontally by N pixels (N>1) vertically and computes a mean pixel value in each block. An example of such image division is illustrated in FIG. 2. FIG. 2 illustrates an example in which a full high-definition image of 1920 pixels horizontally by 1080 pixels vertically is divided into blocks that are each of 120 pixels (M=120) horizontally by 120 pixels (N=120) vertically. The aspect ratio of each pixel is assumed to be equal, and when M and N are equal, each divided block is square in shape. The shape of the divided blocks is not limited to a square, but a square is desirable in order to identify a high-temperature portion. Referring back to FIG. 1, the first-temperature calculation unit 20 converts the mean the pixel value in each block into a temperature. In addition, the first-temperature calculation unit 20 selects a maximum temperature among the plurality of converted temperatures as the first temperature. The first temperature makes it possible to determine whether a high-temperature heat source is present in an environment where the firefighter operates. Upon acquiring information on the first temperature, the, first-temperature calculation unit 20 outputs the information on the first temperature to the estimation unit 21.

The temperature sensor 14 measures a surrounding temperature of an environment where the firefighter operates. The temperature sensor 14 may be implemented by a publicly known technique, and thus description thereof will be omitted herein. The temperature sensor 14 outputs information on the measured surrounding temperature to the second-temperature acquisition unit 22. The second-temperature acquisition unit 22 acquires the information on the surrounding temperature (as mentioned above, referred to as the second temperature) measured by the temperature sensor 14. The second-temperature acquisition unit 22 outputs the information on the second temperature to the estimation unit 24.

The estimation unit 24 receives the information on the first temperature from the first-temperature calculation unit 20 and the information on the second temperature from the second-temperature acquisition unit 22. The estimation unit 24 estimates a surrounding environment on the basis of the information on the second temperature acquired by the second-temperature acquisition unit 22 and the information on the first temperature acquired by the first-temperature calculation unit 20. The surrounding environment corresponds to an environment where the firefighter operates (hereinafter, referred to as an operation environment). The estimation unit 24 stores a table for estimating the operation environment.

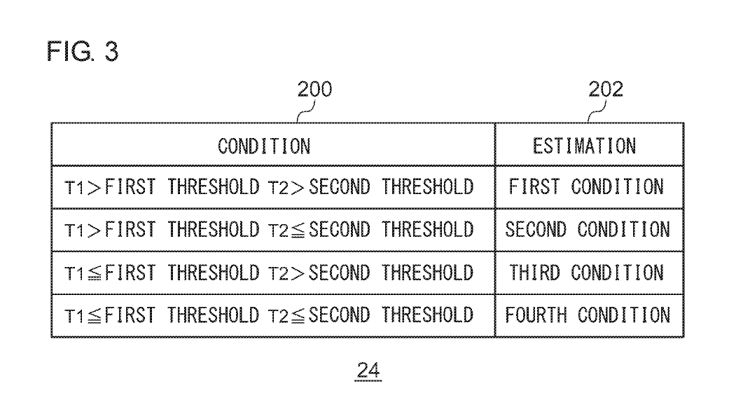

FIG. 3 illustrates a data structure of the table stored in the estimation unit 24. As illustrated in FIG. 3, the table includes a condition column 200 and an estimation column 202. As indicated in the estimation column 202, four conditions, namely, a first condition to a fourth condition are defined in advance for the operation environment in the estimation unit 24. The condition column 200 lists the conditions for classifying the operation environment into any one of the first condition to the fourth condition. Here, T1 represents the first temperature, and T2 represents the second temperature. In addition, a first threshold is a threshold for the first temperature, and a second threshold is a threshold for the second temperature. Each threshold may be set as appropriate. For example, the first threshold may be set to 400° C., and the second threshold may be set to 80° C. Refer back to FIG. 1.

The estimation unit 24 estimates that the operation environment is in the first condition when the first temperature is higher than the first threshold and the second temperature is higher than the second threshold. In this condition, a high-temperature heat source is present within the operation environment, and the surrounding temperature is high. Thus, it is estimated that the firefighter is operating in a dangerous environment. The estimation unit 24 estimates that the operation environment is in the second condition when the first temperature is higher than the first threshold and the second temperature is no higher than the second threshold. In this condition, a high-temperature heat source is present, but the surrounding temperature is low. Thus, it is estimated that the firefighter is operating in an environment where the firefighter is not in immediate danger, because the surrounding temperature is not high even through a high-temperature heat source is present.

The estimation unit 24 estimates that the operation environment is in the third condition when the first temperature is no higher than the first threshold and the second temperature is higher than the second threshold. In this condition, although a high-temperature heat source is not detected, the surrounding temperature is high. Thus, it is estimated that the firefighter is operating in an environment where a high-temperature heat source can be present nearby. The estimation unit 24 estimates that the operation environment is in the fourth condition when the first temperature is no higher than the first threshold and the second temperature is no higher than the second threshold. In this condition, a high-temperature heat source is not present, and the surrounding temperature is low. Thus, it is estimated that the firefighter is operating in a safe environment.

The transmission unit. 26 transmits the information on the operation environment estimated by the estimation unit 24 to the reception device 18 through the network 16. In addition, the transmission unit 26 may append identification information for identifying the firefighter to the information on the operation environment and transmit the result. This makes it possible to determine from which firefighter the received information has been transmitted.

The reception unit 30 receives the information on the operation environment from the estimation device 10 through the network 16. The reception unit 30 transmits the information on the operation environment to the storage unit 32, and the storage unit 32 stores the information on the operation environment. The display unit 34 acquires the information on the operation environment by referring to the storage unit 32 and displays, on a monitor, the operation environment of each firefighter estimated by the estimation unit 24.

This configuration can be implemented in hardware, such as a CPU of a computer, a memory, and an LSI, as desired or in software, such as a program loaded onto a memory. The configuration is depicted herein in the form of functional blocks implemented through cooperation of such hardware and software. It is to be understood by a person skilled in the art that these functional blocks can be implemented in various forms, namely, solely in hardware, solely in software, or through a combination of hardware and software.

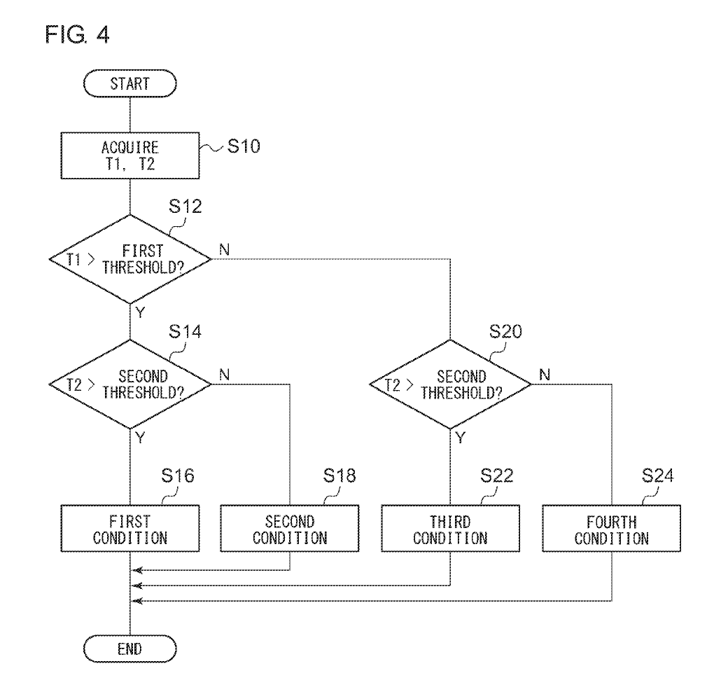

An operation of the estimation system 100 configured as described above will be described with reference to FIG. 4. FIG. 4 is a flowchart illustrating an estimation procedure of the estimation device 10. The first-temperature calculation unit 20 acquires T1, and the second-temperature acquisition unit 22 acquires T2 (S10). If T1 is greater than the first threshold (Y in S12) and T2 is greater than the second threshold (Y in S14), the estimation unit 24 determines that the operation environment is in the first condition (S16). If T2 is not greater than the second threshold (N in S14), the estimation unit 24 determines that the operation environment is in the second condition (S18). If T1 is not greater than the first threshold (N in S12) and T2 is greater than the second threshold (Y in S20), the estimation unit 24 determines that the operation environment is in the third condition (S22). If T2 is not greater than the second threshold (N in S20), the estimation unit 24 determines that the operation environment is in the fourth condition (S24).

According to the present example, the operation environment is estimated on the basis of the information on the first temperature and the information on the second temperature, and thus the operation environment can be estimated automatically. In addition, the process can be simplified because it is simply determined to which one of the plurality of preset conditions the operation environment corresponds. Furthermore, the commander can recognize the environment where each firefighter operates without placing a large load on the firefighter, because the environment where the firefighter operates is estimated automatically and the estimated environment is transmitted.

### EXAMPLE 2

Example 2 will now be described. As in Example 1, Example 2 relates to an estimation system constituted by an estimation device that estimates an operation environment of firefighters and a reception device that receives information on the operation environment from the estimation device. In Example 1, the operation environment of the firefighters is estimated on the basis of the information on the first temperature acquired by the far-infrared camera and the information on the second temperature acquired by the temperature sensor. Meanwhile, in Example 2, the operation environment of each firefighter is estimated with the use of a distance sensor in addition to the far-infrared camera and the temperature sensor, and the estimated operation environment is transmitted to a commander. In other words, as in Example 1, the information on the first temperature is acquired by the far-infrared camera, and the information on the second temperature is acquired by the temperature sensor. In addition, the distance from a heat source is acquired by the distance sensor. The estimation device estimates the operation environment of each firefighter on the basis of the information on the two temperatures and the information on the distance.

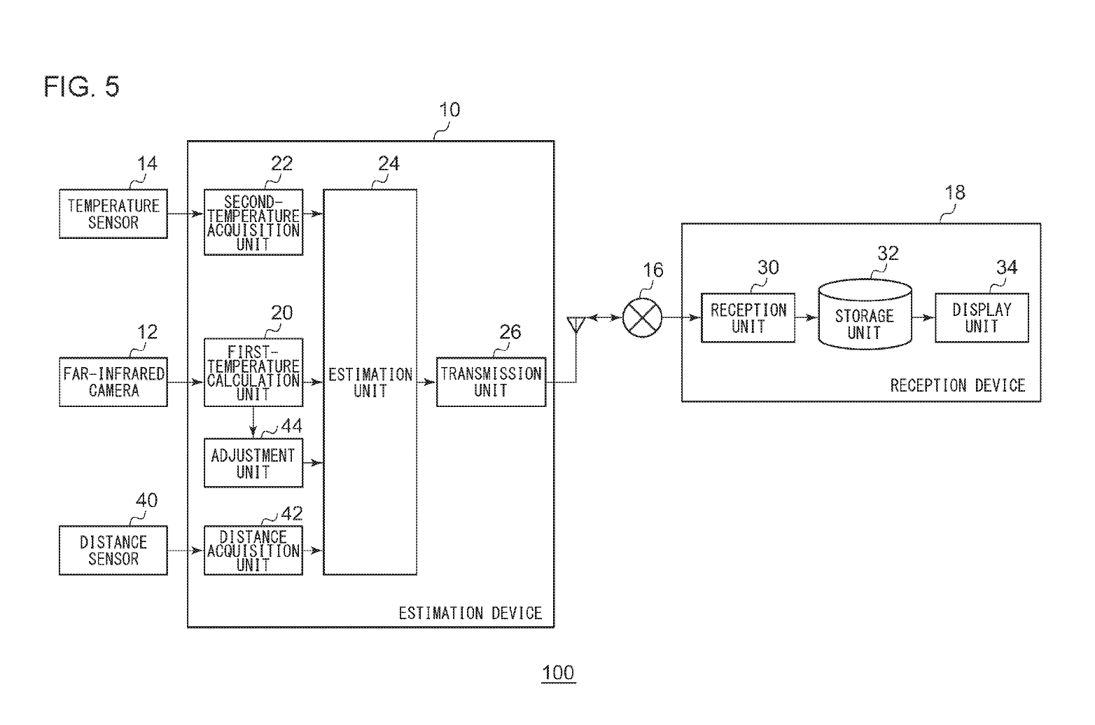

FIG. 5 illustrates a configuration of an estimation system 100 according to Example 2. The estimation system 100 includes an estimation device 10, a far-infrared camera 12, temperature sensor 14, a network 16, a reception device 18, and a distance sensor 40. The estimation device 10 includes a first-temperature calculation unit 20, a second-temperature acquisition unit 22, an estimation unit 24, a transmission unit 26, a distance acquisition unit 42, and an adjustment unit 44. The reception device 18 includes a reception unit 30, a storage unit 32, and a display unit 34.

The distance sensor 40 measures the distance D from a heat source. This corresponds to measuring the distance from a target captured by the far-infrared camera 12. The distance sensor 40 may be implemented by a publicly known technique, and thus description thereof will be omitted herein. The distance sensor 40 outputs information on the measured distance to the distance acquisition unit 42. The distance acquisition unit 42 acquires the information on the distance measured by the distance sensor 40. The distance acquisition unit 42 outputs the information on the distance to the estimation unit 24.

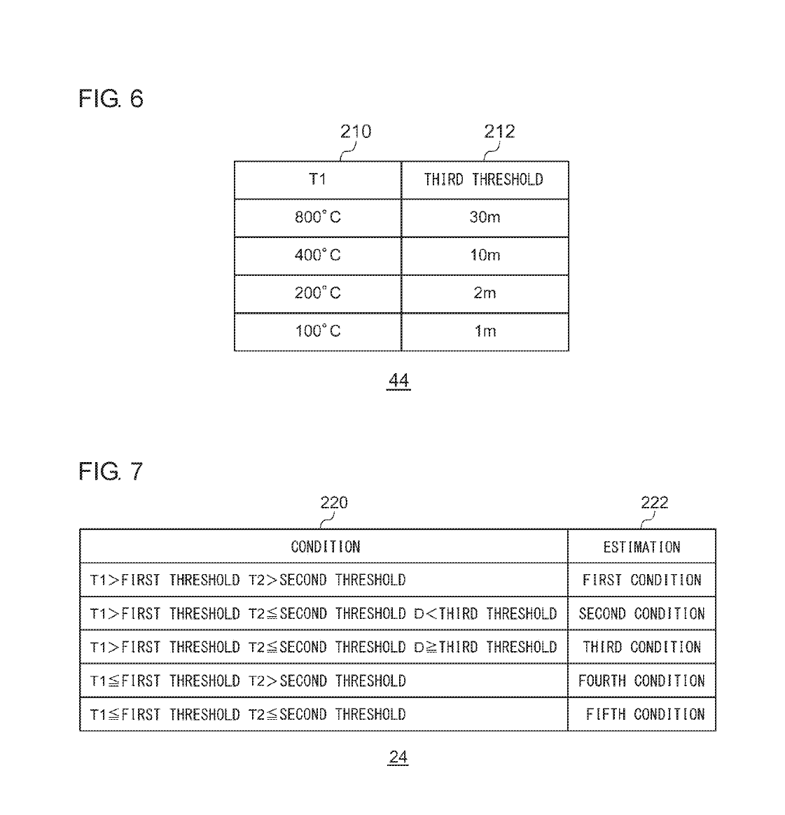

The adjustment unit 44 receives information on the first temperature from the first-temperature calculation unit 20. On the basis of the information on the first temperature, the adjustment unit 44 adjusts a third threshold in the estimation unit 24. The third threshold is a threshold against which the information on the distance acquired by the distance acquisition unit 42 is compared. The adjustment unit 44 uses a table to adjust the third threshold. FIG. 6 illustrates a data structure of the table stored in the adjustment unit 44. As illustrated in FIG. 6, the table includes a T1 column 210 and a third threshold column 212. The T1 column 210 lists the first temperatures, and the third threshold column 212 lists the third thresholds corresponding to the respective first temperatures.

For example, when the first temperature is 400° C., the third threshold is 10 m. When the adjustment unit 44 acquires information on the first temperature other than the first temperatures illustrated in FIG. 6, the adjustment unit 44 interpolates to derive the third threshold. For example, when the first temperature is 600° C., the adjustment unit 44 derives 20 m as the third threshold. Meanwhile, when the acquired first temperature is higher than 800° C., or when the acquired first temperature is lower than 100° C., the adjustment unit 44 extrapolates to derive the third threshold. Alternatively, when the adjustment unit 44 acquires information on the first temperature other than the first temperatures illustrated in FIG. 6, the adjustment unit 44 may select any one of the first temperatures illustrated in FIG. 6. Referring back to FIG. 5, the adjustment unit 44 outputs the adjusted third threshold to the estimation unit 24.

The estimation unit 24 receives the information on the first temperature from the first-temperature calculation unit 20, the information on the second temperature from the second-temperature acquisition unit 22, and the information on the distance acquired by the distance acquisition unit 42. Furthermore, the estimation unit 24 receives the third threshold from the adjustment unit 44. The estimation unit 24 estimates the surrounding environment measured by the temperature sensor 14, or in other words, the aforementioned operation environment on the basis of the information on the first temperature, the information on the second temperature, and the information on the distance acquired by the distance acquisition unit 42. In this case as well, the estimation unit 24 stores a table for estimating the surrounding environment.

FIG. 7 illustrates a data structure of the table stored in the estimation unit 24. As illustrated in FIG. 7, the table includes a condition column 220 and an estimation column 222. As indicated in the estimation column 222, five conditions, namely, a first condition to a fifth condition are defined in advance for the surrounding environment in the estimation unit 24. The condition column 220 lists the conditions for classifying the surrounding environment into any one of the first condition to the fifth condition. Here, D represents the distance. As described above, the third threshold is a threshold for the distance and is adjusted by the adjustment unit 44. Refer back to FIG. 5.

The estimation unit 24 estimates that the operation environment is in the first condition when the first temperature is higher than the first threshold and the second temperature is higher than the second threshold. In this condition, a high-temperature heat source is present within the operation environment, and the surrounding temperature is high. Thus, it is estimated that the firefighter is operating in a dangerous environment. The estimation unit 24 estimates that the operation environment is in in the second condition when the first temperature is higher than the first threshold, the second temperature is no higher than the second threshold, and the distance is smaller than the third threshold. In this condition, it is estimated that the firefighter is operating in an environment where the surrounding temperature is low even though a high-temperature heat source is present nearby.

The estimation unit 24 estimates that the operation environment is in the third condition when the first temperature is higher than the first threshold, the second temperature is no higher than the second threshold, and the distance is no smaller than the third threshold. In this condition, although a high-temperature heat source is present, the surrounding temperature is low. Thus, it is estimated that the firefighter is operating in an environment where the firefighter is not in immediate danger, because the firefighter is at a sufficient distance from the high-temperature heat source even through the high-temperature heat source is present. The estimation unit 24 estimates that the operation environment is in the fourth condition when the first temperature is no higher than the first threshold and the second temperature is higher than the second threshold. In this condition, although a high-temperature heat source is not detected, the surrounding temperature is high. Thus, it is estimated that the firefighter is operating in an environment where a high-temperature heat source can be present nearby. The estimation unit 24 estimates that the operation environment is in the fifth condition when the first temperature is no higher than the first threshold and the second temperature is no higher than the second threshold. In this condition, a high-temperature heat source is not present, and the surrounding temperature is low. Thus, it is estimated that the firefighter is operating in a safe environment.

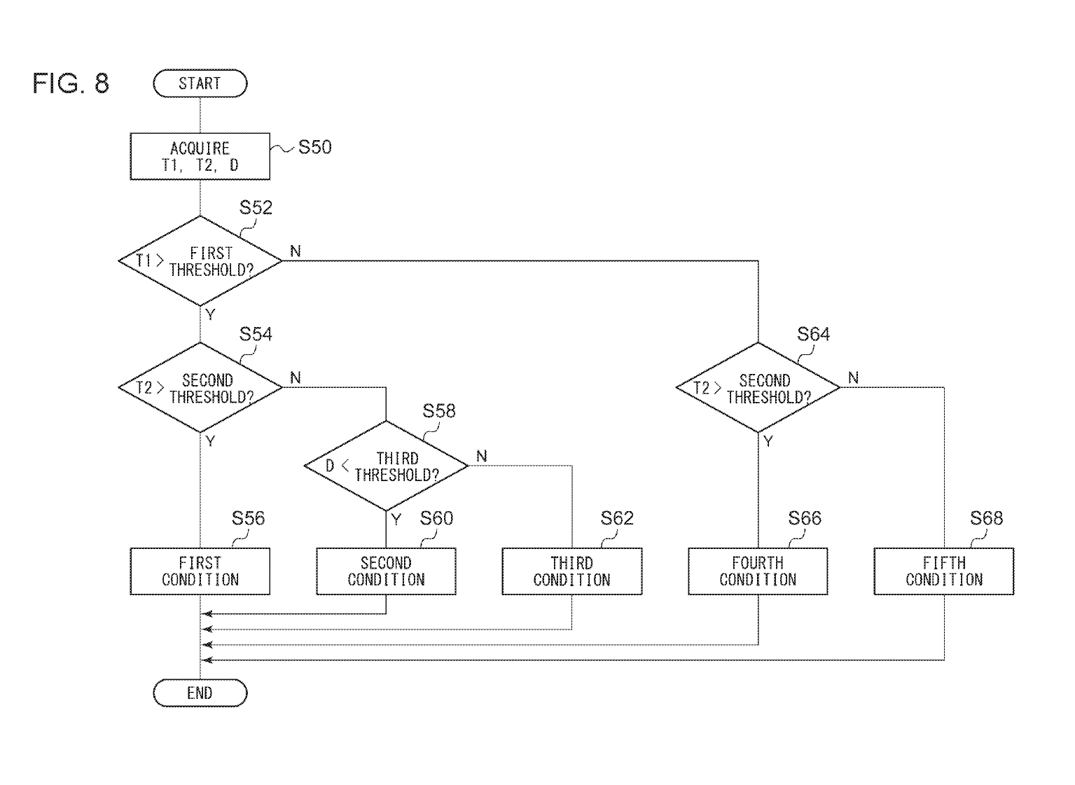

An operation of the estimation system 100 configured as described above will be described. FIG. 8 is a flowchart illustrating an estimation procedure of the estimation device 10. The first-temperature calculation unit 20 acquires T1, the second-temperature acquisition unit 22 acquires T2, and the distance acquisition unit 42 acquires D (S50). If T1 is greater than the first threshold (Y in S52) and T2 is greater than the second threshold (Y in S54), the estimation unit 24 determines that the operation environment is in the first condition (S56). If T2 is not greater than the second threshold (N in S54) and D is less than the third threshold (Y in S58), the estimation unit 24 determines that the operation environment is in the second condition (S60). If D is not less than the third threshold (N in S58), the estimation unit 24 determines that the operation environment is in the third condition (S62). If T1 is not greater than the first threshold (N in S52) and T2 is greater than the second threshold (Y in S64), the estimation unit 24 determines that the operation environment is in the fourth condition (S66). If T2 is not greater than the second threshold (N in S64), the estimation unit 24 determines that the operation environment is in the fifth condition (S68).

According to the present example, the third threshold is set for the distance from a high-temperature heat source, and the operation environment is determined to be in the second condition when the distance from the high-temperature heat source is smaller than the third threshold. Thus, the commander can be informed of danger. In addition, the operation environment is determined to be in the second condition when the distance from the high-temperature heat source is smaller than the third threshold, which makes it possible to determine whether a safe distance is secured from the high-temperature heat source. Not only the temperature but also the distance is taken into consideration, and thus the operation environment can be estimated in detail. In addition, the third threshold is adjusted in accordance with the first temperature, and thus the danger corresponding to the temperature of the heat source can be reflected on the distance.

When the operation environment is estimated to be in the second condition, the distance from the high-temperature heat source may be compared against the third threshold, and the commander may be informed how far the firefighter should move from the current location to stay away from the high-temperature heat source. For example, when the third threshold is 30 m and the distance from the high-temperature heat source is 20 m, the firefighter may move 10 m in the direction away from the high-temperature heat source to bring the operation environment into the third condition. When the operation environment is estimated to be in the third condition, the distance from the high-temperature heat source may be compared against the third threshold, and the commander may be informed how far the firefighter can move from the current location to come closer to the high-temperature heat source. For example, when the third threshold is 30 m and the distance from the high-temperature heat source is 40 m, the third condition can be retained even when the firefighter moves 10 m or less in the direction approaching the high-temperature heat source.

### EXAMPLE 3

Example 3 will now be described. As in Example 1 and Example 2, Example 3 relates to an estimation system constituted by an estimation device that estimates an operation environment of firefighters and a reception device that receives information on the operation environment from the estimation device. As in Example 2, in Example 3, the operation environment of each firefighter is estimated with the use of the distance sensor in addition to the far-infrared camera and the temperature sensor, and the estimated operation environment is transmitted to a commander. In other words, information on the first temperature is acquired by the far-infrared camera, information on the second temperature is acquired by the temperature sensor, and the distance from a heat source is acquired by the distance sensor. The estimation device estimates the operation environment of each firefighter on the basis of the information on the two temperatures and the information on the distance.

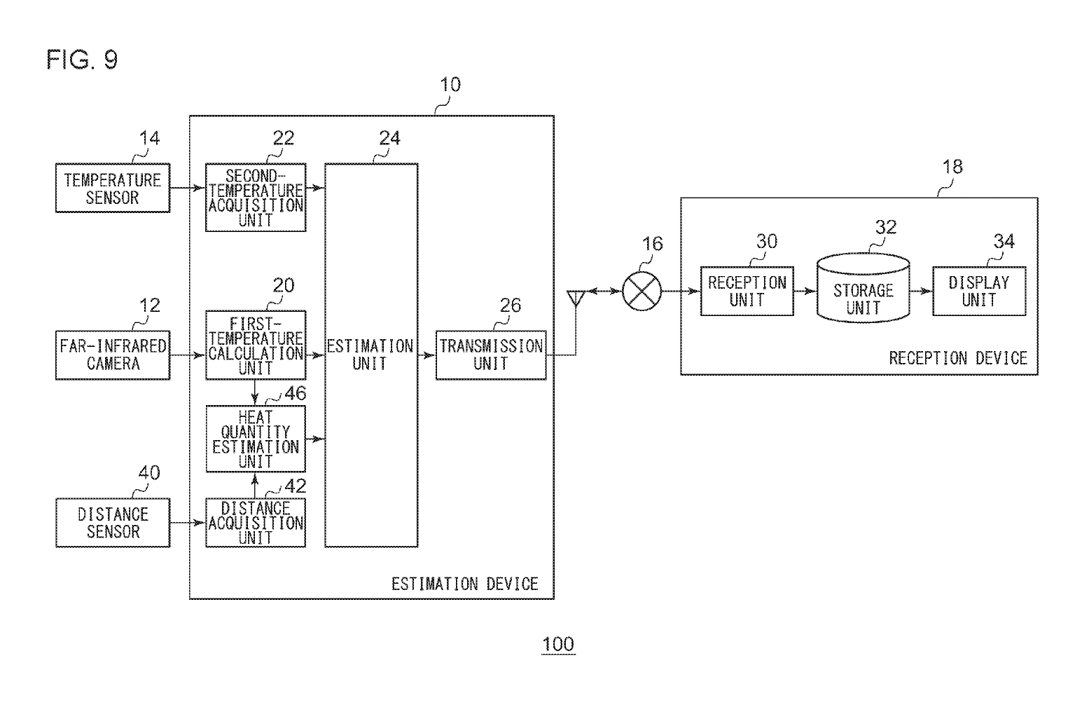

FIG. 9 illustrates a configuration of an estimation system 100 according to Example 3. The estimation system 100 includes an estimation device 10, a far-infrared camera 12, a temperature sensor 14, a network 16, a reception device 18, and a distance sensor 40. The estimation device 10 includes a first-temperature calculation unit 20, a second-temperature acquisition unit 22, an estimation unit 24, a transmission unit 26, a distance acquisition unit 42, and a heat quantity estimation unit 46. The reception device 18 includes a reception unit 30, a storage unit 32, and a display unit 34.

The distance sensor 40 measures the distance D from a heat source. This corresponds to measuring the distance from a target captured by the far-infrared camera 12. The distance sensor 40 may be implemented by a publicly known technique, and thus description thereof will be omitted herein. The distance sensor 40 outputs information on the measured distance to the distance acquisition unit 42. The distance acquisition unit 42 acquires the information on the distance measured by the distance sensor 40. The distance acquisition unit 42 outputs the information on the distance to the estimation unit 24. The first-temperature calculation unit 20 outputs the information on the first temperature to the estimation unit 24 and outputs information on the mean temperature in each block to the heat quantity estimation unit 46.

The heat quantity estimation unit 46 estimates the quantity of heat Q of the heat source on the basis of the information on the distance from the heat source received from the distance acquisition unit 42 and the information on the mean temperature in each block received from the first-temperature calculation unit 20. A method of estimating the quantity of heat will be described. First, the heat quantity estimation unit 46 estimates the size of the heat source on the basis of the information on the mean temperature in each block received from the first-temperature calculation unit 20 and the information on the distance from the heat source received from the distance acquisition unit 42. When the heat source is assumed to be a sphere inscribed in the divided blocks, the diameter R of the heat source is obtained through the following expression (1), in which p represents the cell pitch of a far-infrared detector of the far-infrared camera 12, D represents the distance from the heat source, f represents the focal length of a lens in the far-infrared camera 12, and M represents the number of pixels arrayed vertically or horizontally in a square divided block.

R=p×M×D/f (1)

The quantity of heat Q is calculated next. The quantity of heat Q is obtained through the expression (2).

Q=4π(R/2)²×σT⁴ (2)

In the above, σ represents the Stefan-Boltzmann constant, and T represents the absolute temperature of the first temperature. The quantity of heat Q of the high-temperature heat source estimated by the heat quantity estimation unit 46 is input to the estimation unit 24.

The estimation unit 24 estimates the aforementioned operation environment on the basis of the information on the first temperature from the first-temperature calculation unit 20, the information on the second temperature from the second-temperature acquisition unit 22, and the information on the quantity of heat Q estimated by the heat quantity estimation unit 46. In this case as well, the estimation unit 24 stores a table for estimating the surrounding environment.

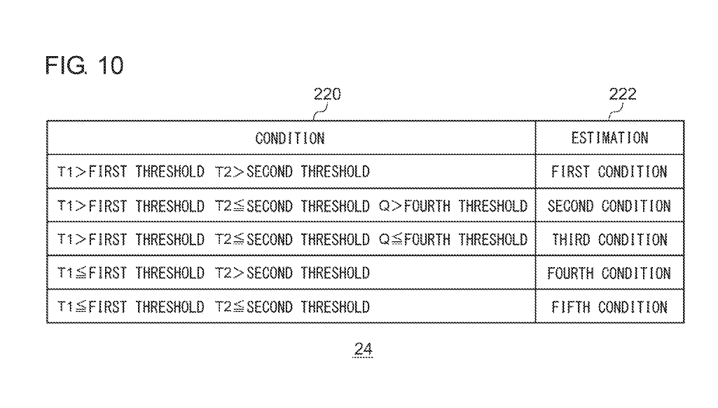

FIG. 10 illustrates a data structure of the table stored in the estimation unit 24. As illustrated in FIG. 10, the table includes a condition column 220 and an estimation column 222. As indicated in the estimation column 222, five conditions, namely, a first condition to a fifth condition are defined in advance for the operation environment in the estimation unit 24. The condition column 220 lists the conditions for classifying the operation environment into any one of the first condition to the fifth condition. A fourth threshold is a threshold for the quantity of heat.

Referring back to FIG. 9, the estimation unit 24 estimates that the operation environment is in the first condition when the first temperature is higher than the first threshold and the second temperature is higher than the second threshold. In this condition, a high-temperature heat source is present within the operation environment, and the surrounding temperature is high. Thus, it is estimated that the firefighter is operating in a dangerous environment. The estimation unit 24 estimates that the operation environment is in the second condition when the first temperature is higher than the first threshold, the second temperature is no higher than the second threshold, and the quantity of heat is larger than the fourth threshold. In this condition, the surrounding temperature is low, but a high-temperature heat source is present. Thus, it is estimated that the firefighter is operating in an environment where the firefighter is being subjected to high radiant heat.

The estimation unit 24 estimates that the operation environment is in the third condition when the first temperature is higher than the first threshold, the second temperature is no higher than the second threshold, and the quantity of heat is no larger than the fourth threshold. In this condition, although a high-temperature heat source is present, the surrounding temperature is low. Thus, it is estimated that the firefighter is operating in an environment where the firefighter is not in immediate danger, because the firefighter is at a sufficient distance from the high-temperature heat source even through the high-temperature heat source is present. The estimation unit 24 estimates that the operation environment is in the fourth condition when the first temperature is no higher than the first threshold and the second temperature is higher than the second threshold. In this condition, although a high-temperature heat source is not detected, the surrounding temperature is high. Thus, it is estimated that the firefighter is operating in an environment where a high-temperature heat source can be present nearby. The estimation unit 24 estimates that the operation environment is in the fifth condition when the first temperature is no higher than the first threshold and the second temperature is no higher than the second threshold. In this condition, a high-temperature heat source is not present, and the surrounding temperature is low. Thus, it is estimated that the firefighter is operating in a safe environment.

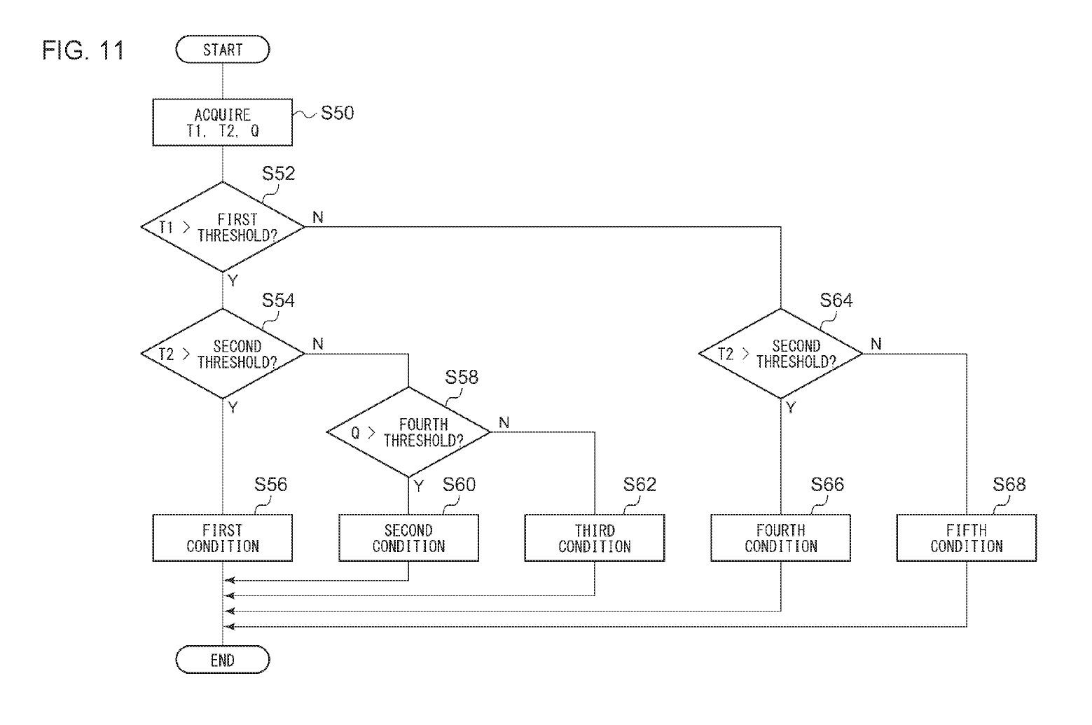

An operation of the estimation system 100 configured as described above will be described. FIG. 11 is a flowchart illustrating an estimation procedure of the estimation device 10. The first-temperature calculation unit 20 acquires T1, the second-temperature acquisition unit 22 acquires T2, and the heat quantity estimation unit 46 acquires Q (S50). If T1 is greater than the first threshold (Y in S52) and T2 is greater than the second threshold (Y in S54), the estimation unit 24 determines that the operation environment is in the first condition (S56). If T2 is not greater than the second threshold (N in S54) and Q is greater than the fourth threshold (Y in S58), the estimation unit 24 determines that the operation environment is in the second condition (S60). If Q is not greater than the fourth threshold (N in S58), the estimation unit 24 determines that the operation environment is in the third condition (S62). If T1 is not greater than the first threshold (N in S52) and T2 is greater than the second threshold (Y in S64), the estimation unit 24 determines that the operation environment is in the fourth condition (S66). If T2 is not greater than the second threshold (N in S64), the estimation unit 24 determines that the operation environment is in the fifth condition (S68).

According to the present example, the fourth threshold is set for the quantity of heat emitted by a high-temperature heat source, and the operation environment is determined to be in the second condition when the quantity of heat emitted by the high-temperature heat source is larger than the fourth threshold. Thus, the commander can be informed of danger. In addition, the operation environment is determined to be in the third condition when the quantity of heat emitted by the high-temperature heat source is no larger than the fourth threshold, which makes it possible to determine whether a safe distance is secured from the high-temperature heat source. Not only the temperature but also the quantity of heat emitted by a high-temperature heat source is taken into consideration, and thus the operation environment can be estimated in detail.

Thus far, examples of the present invention have been described. These examples are illustrative in nature, and it should be appreciated by a person skilled in the art that various modifications can be made to the combinations of the components and the processing processes in the examples and such modifications also fall within the scope of the present invention.

Four conditions are defined in Example 1, and five conditions are defined in Examples 2 and 3. However, these are non-limiting examples, and any other number of conditions may be defined. According to such a modification, the flexibility in configuration can be increased.

What is claimed is:

1. An estimation device, comprising:
a first-temperature calculation unit that calculates, as a first temperature, a maximum temperature within an image region captured by a far-infrared camera;
a second-temperature acquisition unit that acquires, as a second temperature, a surrounding temperature measured by a temperature sensor;
an estimation unit that estimates a surrounding environment measured by the temperature sensor on the basis of information on the second temperature acquired by the second-temperature acquisition unit and information on the first temperature calculated by the first-temperature calculation unit; and
a transmission unit that transmits information on the surrounding environment estimated by the estimation unit.

2. The estimation device according to claim 1, wherein
the estimation unit estimates that
(1) the surrounding environment is in a first condition when the first temperature is higher than a first threshold and the second temperature is higher than a second threshold,
(2) the surrounding environment is in a second condition when the first temperature is higher than the first threshold and the second temperature is no higher than the second threshold,
(3) the surrounding environment is in a third condition when the first temperature is no higher than the first threshold and the second temperature is higher than the second threshold, and
(4) the surrounding environment is in a fourth condition when the first temperature is no higher than the first threshold and the second temperature is no higher than the second threshold.

3. The estimation device according to claim 1, further comprising:
a distance acquisition unit that acquires information on a distance from a target captured by the far-infrared camera, wherein
the estimation unit estimates the surrounding environment measured by the temperature sensor with the information on the distance acquired by the distance acquisition unit taken into consideration as well.

4. The estimation device according to claim 3, wherein
the estimation unit estimates that
(1) the surrounding environment is in a first condition when the first temperature is higher than a first threshold and the second temperature is higher than a second threshold,
(2) the surrounding environment is in a second condition when the first temperature is higher than the first threshold, the second temperature is no higher than the second threshold, and the distance is smaller than a third threshold,
(3) the surrounding environment is in a third condition when the first temperature is higher than the first threshold, the second temperature is no higher than the second threshold, and the distance is no smaller than the third threshold,
(4) the surrounding environment is in a fourth condition when the first temperature is no higher than the first threshold and the second temperature is higher than the second threshold, and
(5) the surrounding environment is in a fifth condition when the first temperature is no higher than the first threshold and the second temperature is no higher than the second threshold.

5. The estimation device according to claim 4, further comprising:
an adjustment unit that adjusts the third threshold in the estimation unit on the basis of the information on the first temperature acquired by the first-temperature calculation unit.

6. The estimation device according to claim 1, further comprising:
a distance acquisition unit that acquires information on a distance from a target captured by the far-infrared camera; and
a heat quantity estimation unit that estimates a quantity of heat of a heat source on the basis of the information on the first temperature calculated by the first-temperature calculation unit and the information on the distance acquired by the distance acquisition unit, wherein
the estimation unit estimates the surrounding environment with the information on the quantity of heat estimated by the heat quantity estimation unit taken into consideration as well.

7. The estimation device according to claim 6, wherein
the estimation unit estimates that
(1) the surrounding environment is in a first condition when the first temperature is higher than a first threshold and the second temperature is higher than a second threshold,
(2) the surrounding environment is in a second condition when the first temperature is higher than the first threshold, the second temperature is no higher than the second threshold, and the quantity of heat is larger than a fourth threshold,
(3) the surrounding environment is in a third condition when the first temperature is higher than the first threshold, the second temperature is no higher than the second threshold, and the quantity of heat is no larger than the fourth threshold,
(4) the surrounding environment is in a fourth condition when the first temperature is no higher than the first threshold and the second temperature is higher than the second threshold, and
(5) the surrounding environment is in a fifth condition when the first temperature is no higher than the first threshold and the second temperature is no higher than the second threshold.

8. An estimation system, comprising:
an estimation device that estimates a surrounding environment; and
a reception device that receives information on the surrounding environment estimated by the estimation device, wherein
the estimation device includes
a first-temperature calculation unit that calculates, as a first temperature, a maximum temperature within an image region captured by a far-infrared camera,
a second-temperature acquisition unit that acquires, as a second temperature, a surrounding temperature measured by a temperature sensor, and
an estimation unit that estimates a surrounding environment measured by the temperature sensor on the basis of information on the second temperature acquired by the second-temperature acquisition unit and information on the first temperature calculated by the first-temperature calculation unit.
